(19) United States
(12) Patent Application Publication
(10) Pub. No.: US 2016/0063897 A1
(43) Pub. Date: Mar. 3, 2016

(54) MEDICAL PRODUCT SUPPORT PLATFORM

(71) Applicant: COVIDIEN LP, MANSFIELD, MA (US)

(72) Inventors: CHRISTOPHER T. RUSIN, GOLDEN, CO (US); SCOTT F. ALEXANDER, WILDWOOD, MO (US); KEITH D. SIGGINS, BOULDER, CO (US); MARTIN J. OSBORN, ERIE, CO (US)

(21) Appl. No.: 14/834,704

(22) Filed: Aug. 25, 2015

Related U.S. Application Data
(60) Provisional application No. 62/042,494, filed on Aug. 27, 2014.
(60) Provisional application No. 62/042,501, filed on Aug. 27, 2014.

(51) Int. Cl. G09B 23/28; G09B 5/02; G09B 5/04; G09B 5/06

(52) U.S. Cl. CPC G09B 23/28; G09B 5/065; G09B 5/02; G09B 5/04

(57) ABSTRACT

A system for providing medical product support to a client device in an operating room is provided. The system includes a processor and memory associated with the processor, the memory including instructions that, when executed by the processor, configures the processor to receive a product support request from the client device, and transmit a web platform including at least one view to the client device in response to the product support request, the at least one view being configured to present the client device with self-help product support information for at least one medical procedure, and the at least one view further presenting at least one medical product associated with the at least one medical procedure.

### CROSS-REFERENCE TO RELATED APPLICATIONS

This application claims the benefit of, and priority to, U.S. Provisional Patent Application Nos. 62/042,494 and 62/042,501, both of which were filed on Aug. 27, 2014. This application is related to U.S. patent application Ser. No. 14/834,671, filed on Aug. 25, 2015. The entire contents of each of the above applications are hereby incorporated herein by reference.

### BACKGROUND

1. Technical Field

The present disclosure relates to a system and method for providing medical product support.

2. Discussion of Related Art

Surgeons and medical staff in and around the operating room often utilize a large variety of medical products for a given surgical procedure. Each product has its own set-up and usage procedures as well as its own troubleshooting methodology. Moreover often each medical product is part of a family of related products having specific and preferred usages for particular procedures or types of procedures. Further, medical procedures themselves are often performed as part of a specific workflow to address physiological concerns in a predetermined order. All of this information regarding the medical products has until now been required learning for surgeons and nurses using such medical products. In an ever information rich environment such as the medical product, medical systems, and medical procedures area the amount of information which an individual must process and retain becomes truly staggering and can lead to individual cases of information paralysis. Accordingly, improved methods of storing, presenting and retaining this information are desired.

### SUMMARY

Provided in accordance with the present disclosure are systems and methods for providing medical product support to a client device in an operating room.

In an aspect of the present disclosure, the system includes a processor and memory associated with the processor, the memory including instructions that, when executed by the processor, configures the processor to receive a product support request from the client device, and transmit a web platform including at least one view to the client device in response to the product support request, the at least one view being configured to present the client device with self-help product support information for at least one medical procedure, and the at least one view further presenting at least one medical product associated with the at least one medical procedure.

In a further aspect of the present disclosure, the self-help product support information for the at least one medical procedure presents at least one step of the at least one medical procedure.

In yet a further aspect of the present disclosure, the at least one medical product associated with the at least one medical procedure is associated with the at least one step of the at least one medical procedure.

In another aspect of the present disclosure, the web platform further includes at least one product specific view configured to present the client device with self-help product support information for the at least one medical product associated with the at least one medical procedure, the at least one medical product being activatable in the self-help product support information for the at least one medical procedure by a user of the client device to access the at least one product specific view.

In a further aspect of the present disclosure, at least one product specific view includes a real-time product support call option that is activatable by the user of the client device to access real-time product support for the activated medical product.

In yet a further aspect of the present disclosure, the real-time product support call option includes at least one of a text-based interface, an audio-based interface, a video-based interface, or an audio-visual based interface.

In another aspect of the present disclosure, the at least one view presenting self-help product support information for the at least one medical procedure includes a real-time product support call option that is activatable by the user of the client device to access real-time product support for the at least one medical procedure.

In a further aspect of the present disclosure, the real-time product support call option includes at least one of a text-based interface, an audio-based interface, a video-based interface, or an audio-visual based interface.

In an aspect of the present disclosure, a non-transitory computer-readable storage medium is encoded with instructions that, when executed by a processor, configures the processor to receive a product support request from the client device, and transmit a web platform including at least one view to the client device in response to the product support request, the at least one view being configured to present the client device with self-help product support information for at least one medical procedure, the at least one view further presenting at least one medical product associated with the at least one medical procedure.

In a further aspect of the present disclosure, the self-help product support information for the at least one medical procedure presents at least one step of the at least one medical procedure.

In yet a further aspect of the present disclosure, the at least one medical product associated with the at least one medical procedure is associated with the at least one step of the at least one medical procedure.

In another aspect of the present disclosure, the web platform further includes at least one product specific view configured to present the client device with self-help product support information for the at least one medical product associated with the at least one medical procedure, the at least one medical product being activatable in the self-help product support information for the at least one medical procedure by a user of the client device to access the at least one product specific view.

In a further aspect of the present disclosure, the at least one product specific view includes a real-time product support call option that is activatable by the user of the client device to access real-time product support for the activated medical product.

In yet a further aspect of the present disclosure, the real-time product support call option includes at least one of a text-based interface, an audio-based interface, a video-based interface, or an audio-visual based interface.

In another aspect of the present disclosure, the at least one view presenting self-help product support information for the at least one medical procedure includes a real-time product support call option that is activatable by the user of the client device to access real-time product support for the at least one medical procedure.

Any of the above aspects and embodiments of the present disclosure may be combined without departing from the scope of the present disclosure.

### BRIEF DESCRIPTION OF THE DRAWINGS

Objects and features of the presently disclosed system and method will become apparent to those of ordinary skill in the art when descriptions of various embodiments thereof are read with reference to the accompanying drawings, of which:

FIG. 1 is a system diagram of a medical product support system in accordance with an illustrative embodiment of the present disclosure;

FIG. 2 is a schematic diagram of the medical product support system of FIG. 1;

FIG. 3A is a flow chart illustrating a method of providing medical product support using a web platform in accordance with an embodiment of the present disclosure;

FIG. 3B is a flow chart illustrating a method of providing medical product support using a web platform in accordance with an embodiment of the present disclosure which includes the Urgent Response Option;

FIG. 4 is an initial view of the web platform illustrating both self-help and real-time product support options;

FIG. 5 is a view of the web platform illustrating a medical product family and medical products available for activation by a user;

FIG. 6 is a view of the web platform illustrating medical product support for the activated medical product;

FIG. 7A is a view of the web platform illustrating a setup/use tab providing medical product support for the activated medical product;

FIG. 7B is a view of the web platform illustrating a common questions tab providing medical product support for the activated medical product;

FIG. 8 is a view of the web platform illustrating a medical procedure family and medical procedures available for activation by the user;

FIG. 9 is a view of the web platform illustrating medical procedure support for the activated medical procedure including a procedure overview;

FIG. 10 is a view of the web platform illustrating a steps tab providing information regarding the steps of the activated medical procedure;

FIG. 11 is a view of the web platform illustrating the steps tab of FIG. 10 providing associated products for a particular step in the activated medical procedure;

FIG. 12 is a view of the web platform illustrating an associated products tab providing associated products for the activated medical procedure;

FIG. 13 is a view of the web platform illustrating a list of available real-time product support staff members for activation as a primary product support staff member;

FIG. 14 is a view of the web platform illustrating a real-time product support interface; and

FIG. 15 is a view of the web platform illustrating a result output of a textual query for a particular product support issue

### DETAILED DESCRIPTION

The present disclosure provides a system and method for medical product support. In one embodiment, the system provides medical staff in an operating room (OR), monitoring the OR, or in communication with the OR, on-demand medical product related support. The system and method provides a web based product support platform that is accessible by the medical staff to answer any questions that the medical staff may have regarding medical product selection, preparation of a medical product for use, medical product use, and/or medical product troubleshooting. This web-based platform is accessible via the hospital network, either wired or wireless via any computer, tablet or other internet connected device. The product support platform includes a number of self-service resources including product specific resources and procedure specific resources, and the capability to initiate a text, voice, and/or video-conference real-time product support on-demand with one or more product support staff associated with the product manufacturer. The disclosed medical product support system provides the medical staff in or associated with an OR the ability to streamline workflow and provide improved patient care through real-time support around the use of medical products used in the OR.

As used herein, the term “medical staff” relates to any clinician, nurse, medical professional, or other staff that interacts directly or indirectly with an OR and/or with medical products used in the OR. Although the present system and method is directed toward medical product support in the OR, it is also contemplated that the system and method described herein may also be utilized for non-OR related products or procedures without departing from the scope of the present disclosure, such as but not limited to, emergency rooms, patient's homes, other medical care related locations where medical products are used and supported.

As used herein, the term “real-time product support” includes text, voice, video-conference, and/or any other type of direct communication with product support staff.

Although the present disclosure will be described in terms of specific illustrative embodiments, it will be readily apparent to those skilled in this art that various modifications, rearrangements and substitutions may be made without departing from the spirit of the present disclosure. The scope of the present disclosure is defined by the claims appended hereto.

A. The Product Support System

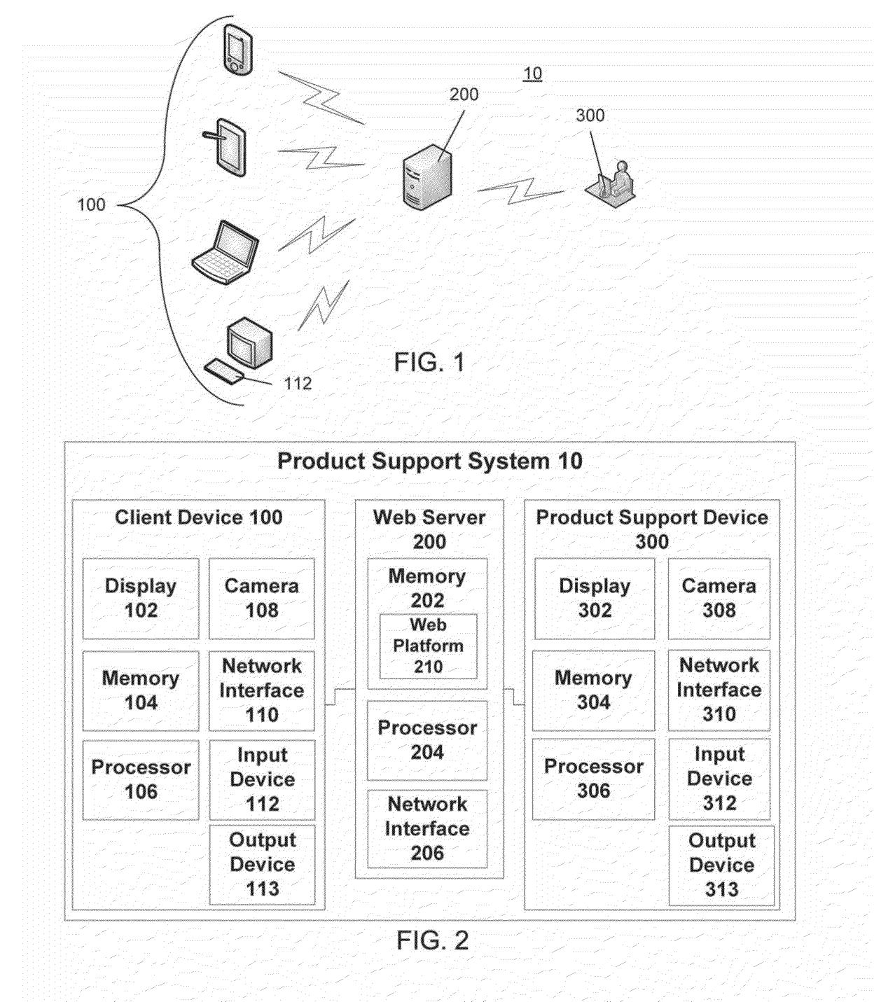

Referring now to FIGS. 1 and 2, the present disclosure is generally directed to a medical product support system 10, which includes a client device 100, a web server 200, and a product support device 300. The client device 100 may be a computing device, for example, a medical workstation, laptop, desktop, tablet, smart phone, or other similar device, having a display 102, memory 104, at least one processor 106, a camera 108, a network interface 110, input device 112, output device 113, and/or other components of the type typically found in a computing device, as depicted in FIG. 2. Display 102 may be touch sensitive and/or voice activated, enabling display 102 to serve as both input device 112 and output device 113. Input device 112 may include, for example, a keyboard 112, mouse (not shown), or other common input devices. Camera 108 may also or alternatively be utilized as input device 112 where, for example, gestures of a user may be captured and processed by processor 106 to control client device 100. Display 102 may be a separate device that is attached to or in communication with client device 100 via a wired or wireless connection. For example, display 102 may include a computer screen, boom mounted display in the OR or another clinical setting, a projector for projecting images onto walls of an OR or another clinical setting, a head mounted display such as augmented reality glasses, a display embedded in a mobile controllable robotic platform, a robotic surgery display, or any other type of display commonly utilized in a hospital. Output device 113 may include, for example, audio outputs, visual outputs, or other similar outputs. Network interface 110 may be connected to a distributed network or the internet via a wired or wireless connection for the transmission and reception of data to and from other sources such as, for example, web server 200 and product support device 300. For example, client device 100 may initiate a connection with web server 200 and/or product support device 300 to transmit data to and receive data from web server 200 and/or product support device 300.

Memory 104 includes any non-transitory computer-readable storage media for storing data and/or software that is executable by processor 106 and which controls the operation of the client device 100. In an embodiment, the memory 104 may include one or more solid-state storage devices such as flash memory chips. Alternatively or in addition to the one or more solid-state storage devices, memory 104 may include one or more mass storage devices connected to the processor 106 through a mass storage controller (not shown) and a communications bus (not shown). Although the description of computer-readable media contained herein refers to a solid-state storage, it should be appreciated by those skilled in the art that computer-readable storage media can be any available media that can be accessed by the processor 106. That is, computer readable storage media includes non-transitory, volatile and non-volatile, removable and non-removable media implemented in any method or technology for storage of information such as computer-readable instructions, data structures, program modules or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium which can be used to store the desired information and which can be accessed by the client device 100.

Web server 200 includes a memory 202, at least one processor 204, a network interface 206, and other components of the type typically found in a server. Memory 202 and processors 204 are similar to memory 104 and processor 106 as described above and will not be described here in more detail. Network interface 206 is connected to a distributed network or the internet via a wired or wireless connection for transmission and reception of data to and from client device 100 and/or product support device 300. Web server 200 provides a web platform 210 that is stored in memory 202 and is accessible to a user of client device 100 or a product support representative using product support device 300. Web platform 210 includes medical product information such as, for example, product descriptions, product use instructions, product troubleshooting, and procedure overviews. Web platform 210 also provides the user of the client device 100 access to on-demand text, voice, or video conference product support with a representative using product support device 300. Medical products used by the hospital staff in the hospital, OR, or for a specific procedure being performed in the OR may also include RFID tags or indoor proximity systems (beacons) that may be tracked by web platform 210 via client device 100 and web platform 210 may present to client device 100 content and information related to the tracked medical products while removing or hiding content related to medical devices that are not in use at the hospital, OR, or for the specific procedure. Web platform 210 will be described in more detail below.

Product support device 300 may be a computing device including a display 302, memory 304, at least one processor 306, camera 308, network interface 310, input device 312 and/or other components of the type typically found in a computing device. Display 302, memory 304, processor 306, camera, 308, network interface 310, input device 312, and output device 313 of product support device 300 are similar to display 102, memory 104, processor 106, camera, 108, network interface 110, input device 112, and output device 113 of client device 100 and will not be described in further detail. Network interface 310 is connected to a distributed network or the internet via a wired or wireless connection for transmission and reception of data to and from client device 100 and/or web server 200.

B. The Web Platform

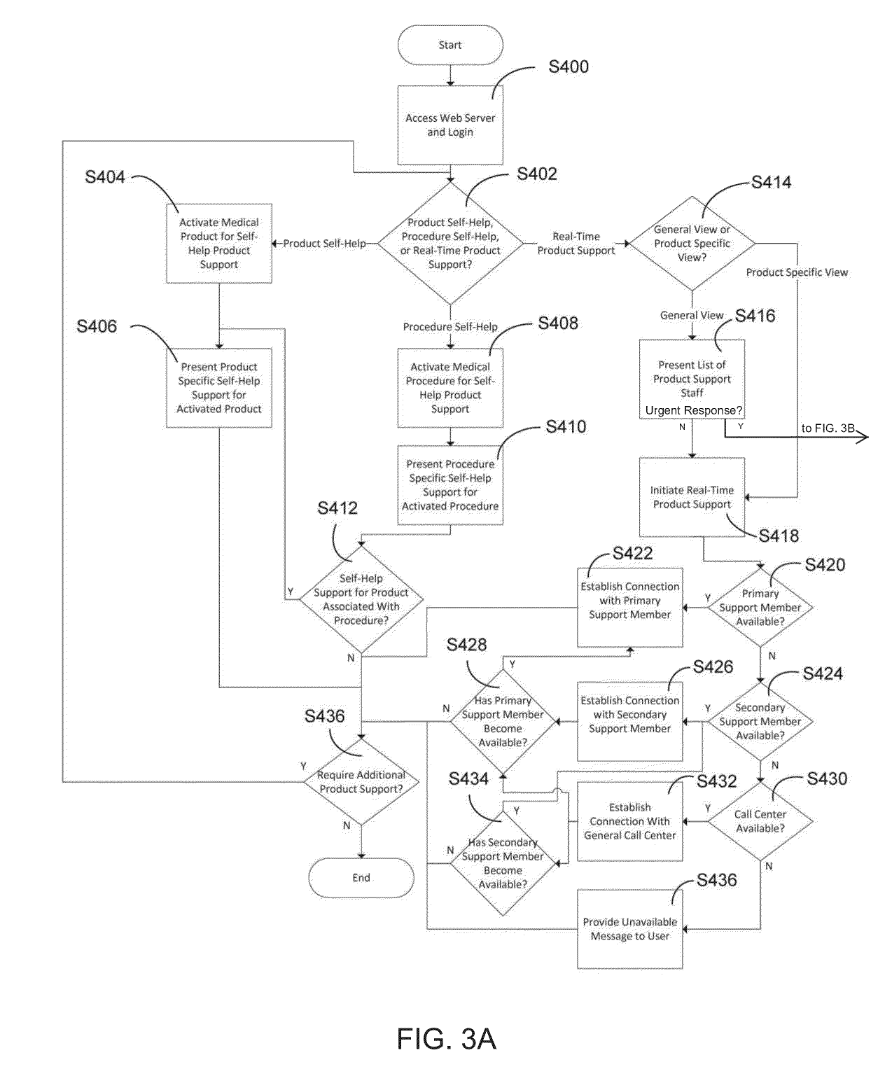

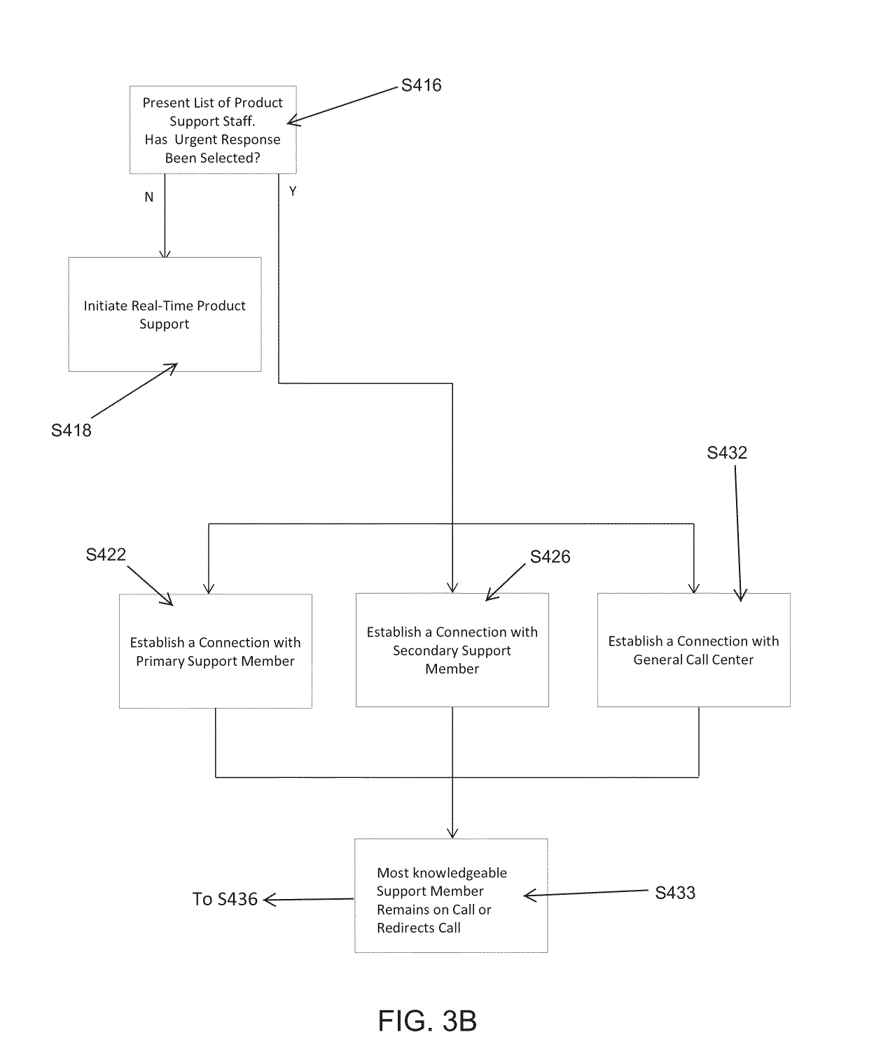

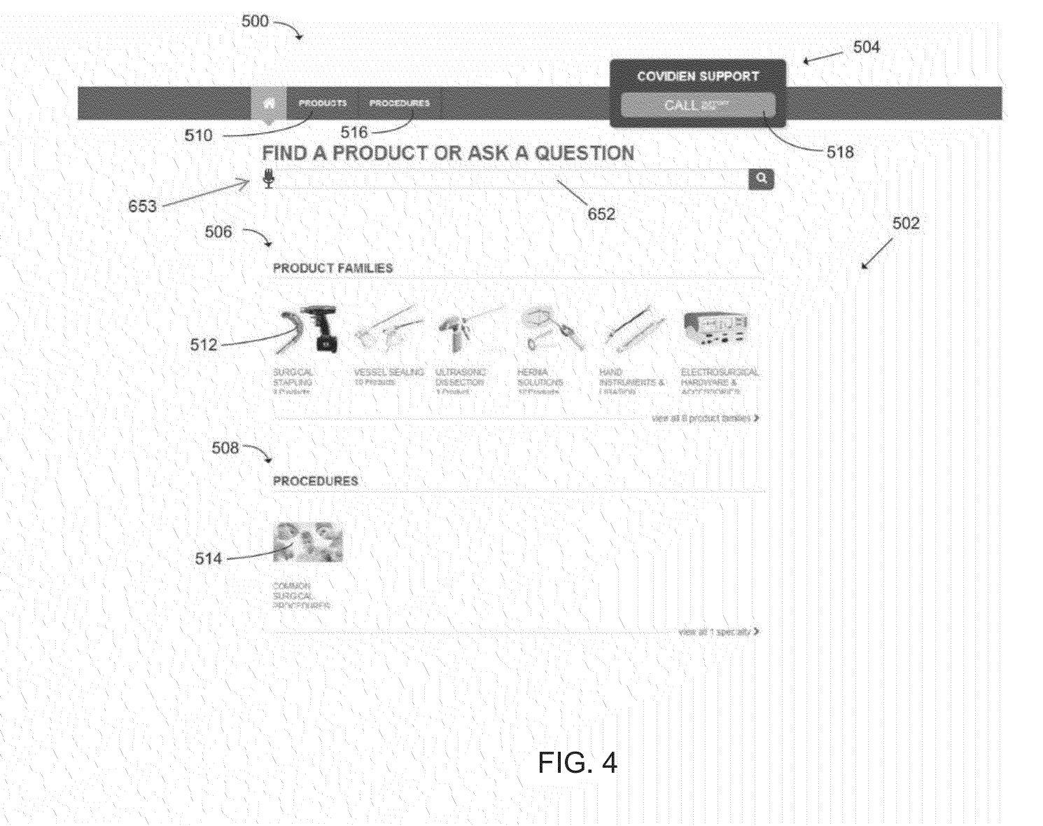

Web server 200 provides a connected client device 100 with access to product support and information via web platform 210. For example, web platform 210, e.g., a web page, a downloadable file, or an application, is downloaded or accessed by client device 100 from web server 200 and displayed on display 102 of client device 100 for a user of client device 100. Web platform 210 will now be described in the context of a client device 100 obtaining product support from web server 200 and/or product support device 300 as shown, for example, in the flowchart of FIG. 3.

Initially, a user of client device 100, for example, the clinician or other medical staff in or associated with the OR, accesses web server 200 and is presented with a login page (not shown) requiring the user to enter login credentials in step S400. For example, the user may enter a hospital specific key, username and password, an OR specific key, a type of physical security token carried by the user like a fob key, or other similar login credentials usable for authentication and identification of the user, the OR, and/or the hospital. The login credentials authenticate the user, OR, and/or hospital site to web server 200 and allow the web server 200 to provide directed product support via web platform 210 to the user based on the authenticated login credentials. As a brief example, the login credentials may be used to tailor the product support features of web platform 210 to a specific user, OR, and/or hospital.

Once the user has been authenticated, web platform 210 presents the user with a view 500 that provides the user with various product support options as shown, for example, in FIG. 4. For example, view 500 provides the user with self-help product support options 502 and a real-time product support option 504. Although described separately, it is contemplated that the user may access a combination of self-help product support options 502 and real-time product support option 504 at the same time.

Self-help product support options 502 include medical product families 506 and medical procedures 508. Each medical product family 506 provides product specific support for the medical products associated with a specific type or line of medical products. Examples of some medical product families 506 include surgical stapling, vessel sealing, ultrasonic dissection, hernia solutions, hand instruments & ligation, electrosurgical hardware & accessories, trocars & access instruments, and wound closure. The above list of medical product families 506 is provided as an example only and shall not be considered limiting. It is further contemplated that self-help product support may be provided for any other medical product family without departing from the scope of the present disclosure. The user may activate a “products” button 510 of view 500 to access a list of medical product families 506 or may alternatively activate a specific medical product family 506, for example, the surgical stapling product family 512, to access product support for medical products associated with the activated medical product family 506.

Medical procedures 508 provide the user with product and procedure specific support for medical products associated with a particular procedure or family of procedures. For example, the user may receive self-help product support related to common surgical procedures 514, specialty surgical procedures, or any other kind of surgical procedure without departing from the scope of the present disclosure. The user may activate a “procedures” button 516 of view 500 to access a list of available medical procedures or may alternatively activate a specific family of medical procedures, for example, common surgical procedures 514, to access product and procedure specific support for medical procedures associated with the specific family of medical procedures.

Real-time product support option 504 provides the user with on-demand real-time support with product support staff including, for example, text, voice, video-conference, and/or any other type of direct communication with the product support staff. Real-time product support option 504 is persistently available in each view presented by web platform 210 and accessible by the user at any time to receive real-time product support. For example, the user may activate a “call support now” button 518 of view 500 at any time to access real-time product support option 504. Real-time product support option 504 may also be context sensitive where, for example, activating the “call support now” button 518 while viewing a particular product, family of products, procedure, or family of procedures may provide the user with a connection to a real-time product support staff member that is specialized in the particular product, family of products, procedure, or family of procedures that the user is viewing. Activation of the real-time product support option 504 will be described in further detail below.

In step S402, for example, the user chooses between self-help product support options 502 and the real-time product support option 504 by activating one of “products” button 510, “procedures” button 516, a specific medical product family for example, surgical stapling product family 512, a specific family of medical procedures, for example, common surgical procedures 514, or “call support now” button 518 of view 500. Although described with reference to view 500 in FIG. 4, it is contemplated that “products” button 510 and “procedures” button 516 may be activated at any time from any other view presented by web platform 210.

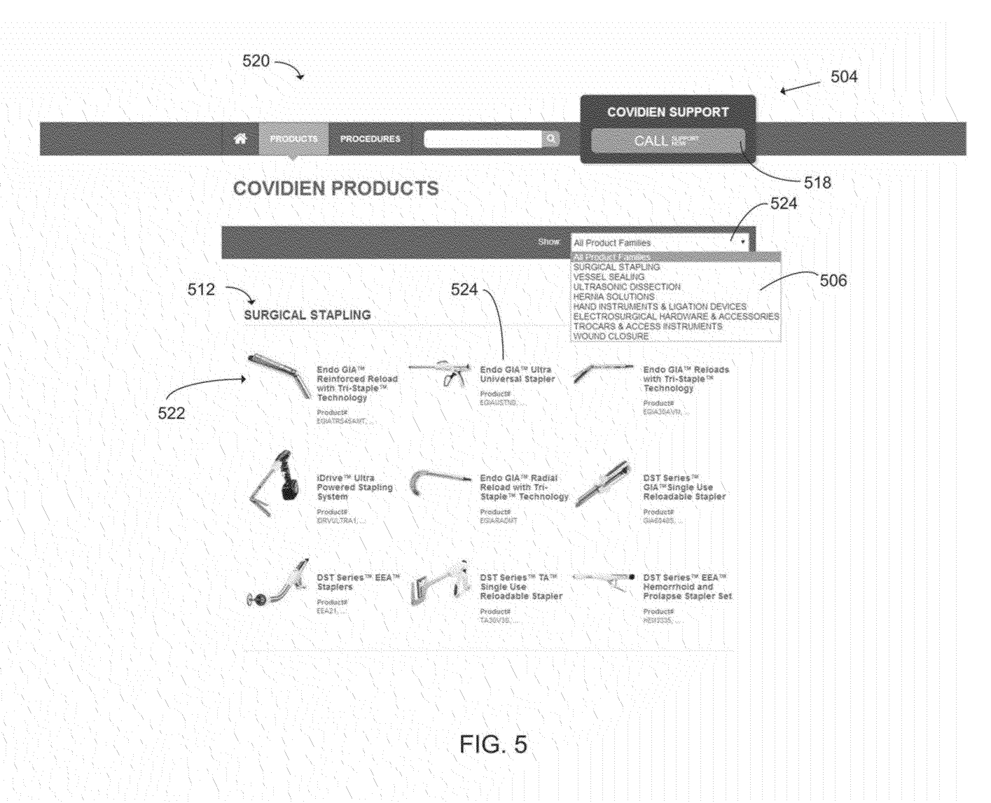

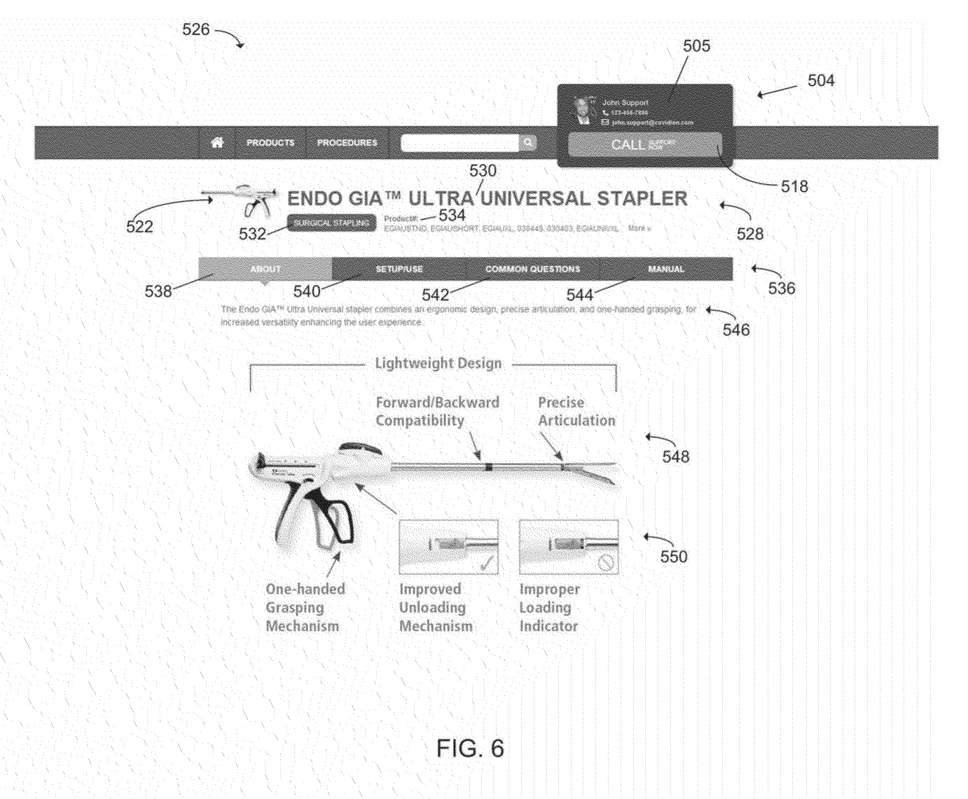

If “products” button 510 or a specific medical product family 506 is activated, web platform 210 presents the user with a view 520, as shown, for example, in FIG. 5. View 520 provides the user with one or more medical product families, for example, the surgical stapling product family 512, including one or more medical products 522. The medical products 522 may be presented to the user as a list, thumbnails, or other similar formats. The clinician may scroll view 520 to view additional product families and may activate a selection menu 524 and choose to view all product families 506 or a particular product family for presentation by view 520.

Each medical product 522 is activatable by the user to access specific product support information relating to that product. In step S404, the user activates a medical product 522, for example, the ENDO GIA™ Ultra Universal Stapler 524, to access additional self-help product support relating to the Endo GIA™ Ultra Universal Stapler 524. Alternatively, the user may scan an encoded image and/or other unique identifier on a medical product to be used in a procedure in the OR or currently in use in the OR using an encoded image and/or other unique identifier scanner associated with client device 100 to access the specific product support information relating to the scanned medical product (e.g., QR codes, barcodes, RFID tags, or others). Client device 100 and/or web platform 210 may alternatively utilize image processing to visually detect the type of medical product held in front of camera 108 by a user and may provide or activate product specific support for the detected medical product without other further user interaction. In addition, the specific product support provided by web platform 210 may be determined based on the appearance of the medical product where, for example, if a component of the medical product appears to be functioning incorrectly, web platform 210 may direct the user to information related to common issued with the particular component. Real-time product support option 504 may be automatically activated by web platform 210 upon scanning of the encoded image or other unique identifier or visual detection of the type of medical product.

Once a medical product 522 has been activated in step S404, web platform 210 presents the user with a view 526 in step S406 providing the user with additional information related to the activated medical product 522. View 526 presents the user with product identifying information 528 including, for example, product name 530, product family 532, and relevant product identification numbers 534. View 526 also includes a menu bar 536 that is activatable by the user to provide the user with categorized functional information related to the activated medical product 522, in this example, the Endo GIA™ Ultra Universal Stapler. Menu bar 536 includes an “about” tab 538, a “setup/use” tab 540, a “common questions” tab 542, and a “manual” tab 544. Each tab 538, 540, 542, and 544 is independently activatable by the user to present product specific information for the activated medical product 522. The above list of tabs 538, 540, 542, and 544 is provided as an example only and shall not be considered limiting. It is further contemplated that self-help product support may remove the above listed tabs or include additional tabs without departing from the scope of the present disclosure.

As shown in FIG. 6, for example, “about” tab 538 provides the user with general information relating to the activated medical product 522 including, for example, a brief description of the product 546, relevant features of the product 548 including an image or picture of the product, and or the basic usage and/or loading principles of the product 550.

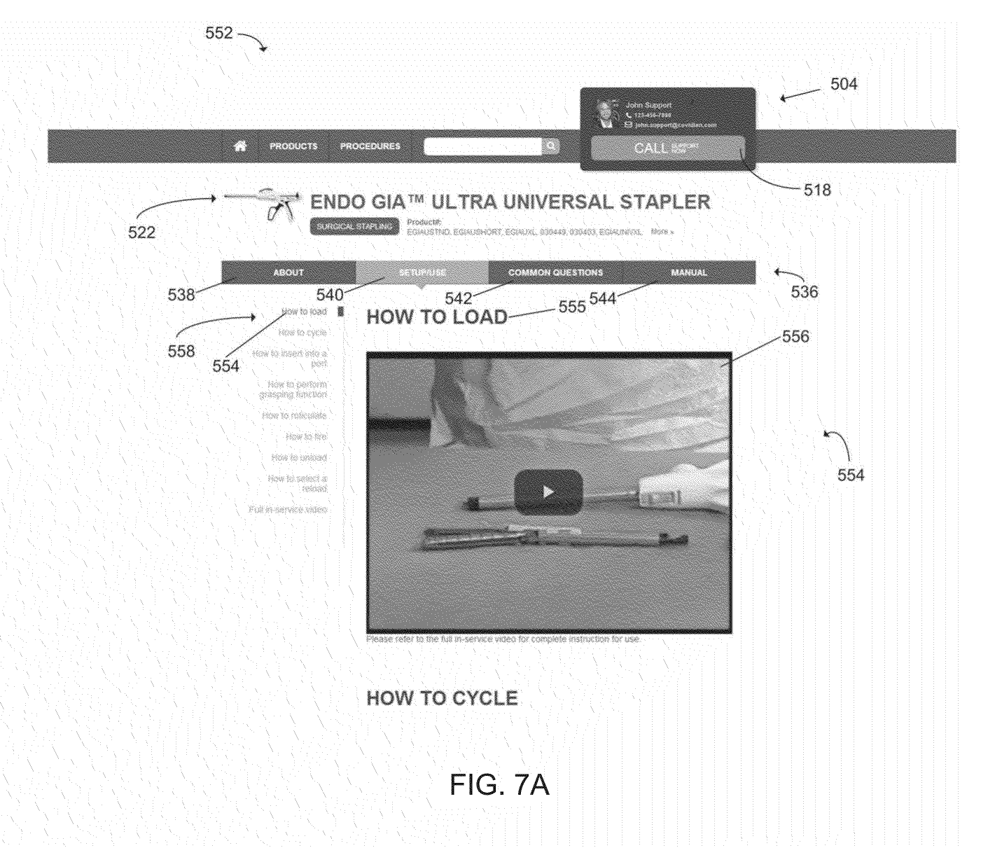

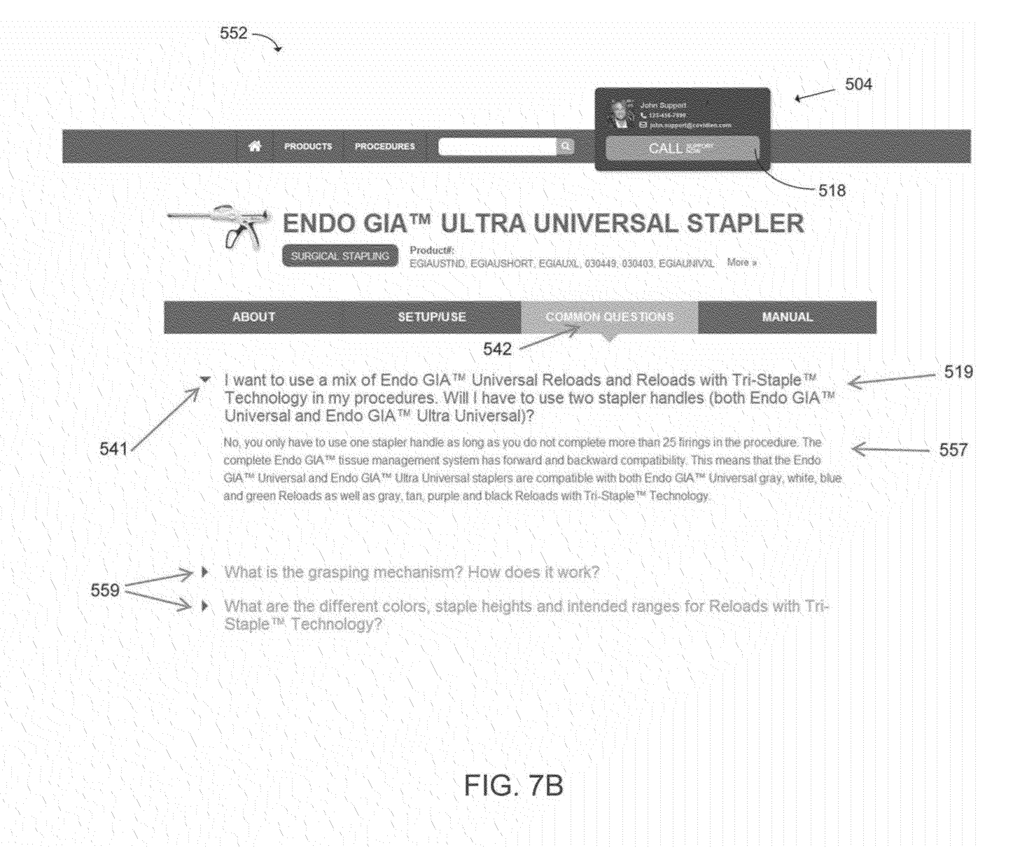

As shown in FIG. 7A, for example, when the user activates the “setup/use” tab 540, web platform 210 presents the user with a view 552 that provides the user with specific information relating to the setup and/or use of the activated medical product 522. For example, view 552 provides the user with specific product setup and/or use instruction sections 554. Each instruction section 554 provides detailed instruction on how to perform the particular setup and or usage step 555, for example, by describing the detailed instruction in text form, with pictures, or through the use of a video tutorial 556. The user may scroll through the available instruction sections 554 using input device 112. A list 558 of available instruction sections 554 may also be provided in view 552 to allow the user to quickly access a desired instruction section 554. Medical products in use in the OR may also be interfaced with or connected to client device 100 where, for example, client device 100 may detect potential issues in the operation of the medical products or receive error codes from the medical products and transmit the detected or received issues/error codes to web platform 210. Web platform 210 may then automatically guide the user to the appropriate location within web platform 210, for example, the appropriate instruction section 554 relating to the user's problem, for targeted product support.

Activation of the “common questions” tab 542 provides the user with the answers to frequently asked questions, as shown, for example in FIG. 7B. For example, view 552 provides the user with common questions regarding each specific product through common questions sections 541. Each common question section 541 provides detailed answers 557 to each specific question 519. The user may select from the listing of common questions sections 541 using input device 112. A list 559 of available common questions 541 may also be provided in view 552 to allow the user to quickly access detailed answers 557. Upon selection of a common question 541, the detailed answer 557 is displayed below.

Medical products in use in the OR may also be interfaced with or connected to client device 100 where, for example, client device 100 may detect potential issues in the operation of the medical products or receive error codes from the medical products and transmit the detected or received issues/error codes to web platform 210. Web platform 210 may then automatically guide the user to the appropriate location within web platform 210, for example, the appropriate common question 541 relating to the user's problem, for targeted product support.

Activation of the “manual” tab 544 provides the user with a downloadable product brochure or manual for the activated medical product.

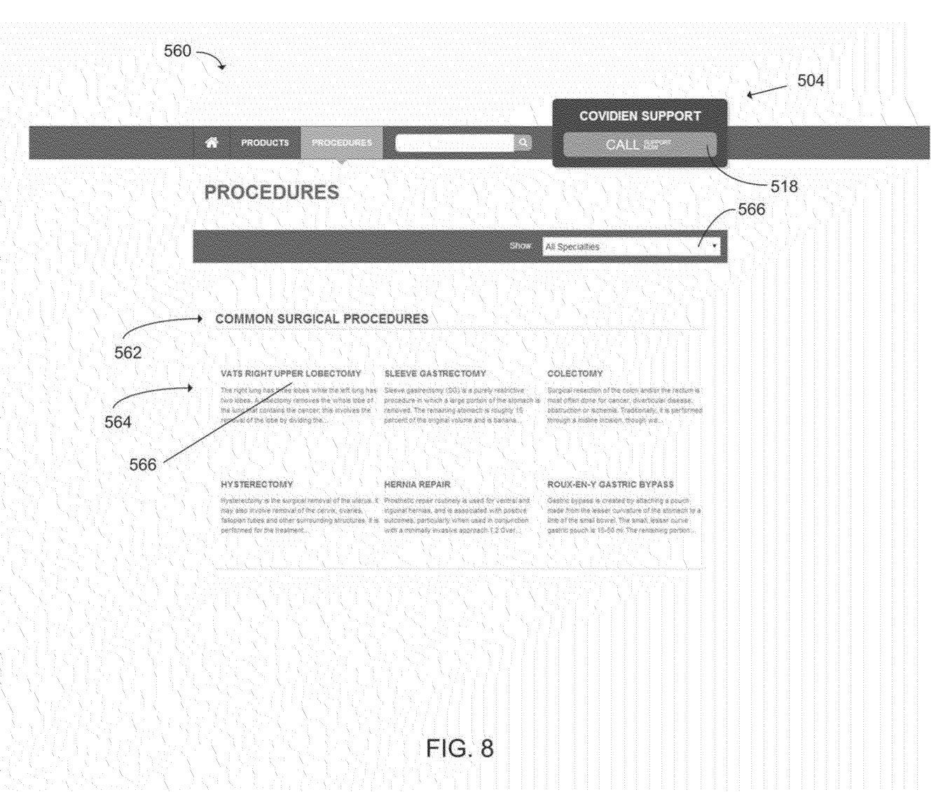

If “procedures” button 516 or a specific medical procedure or family of medical procedures 508 is activated, web platform 210 presents the user with a view 560, as shown, for example, in FIG. 8. View 560 provides the user with one or more families of medical procedures, for example, common surgical procedures 562, including one or more medical procedures 564. The medical procedures 564 may be presented to the user as a list, thumbnails, or other similar formats. The clinician may scroll view 560 to view additional families of medical procedures and may activate a selection menu 566 and choose to view all medical procedures or a particular family of medical procedures for presentation by view 560 similar to that described above for selection menu 524.

Each medical procedure 564 is activatable by the user to access specific product support information relating to the activated medical procedure 564. In step S408, the user activates a medical procedure 564, for example, the VATS Right Upper Lobectomy procedure 566, to access additional self-help product support relating to the activated medical procedure 564.

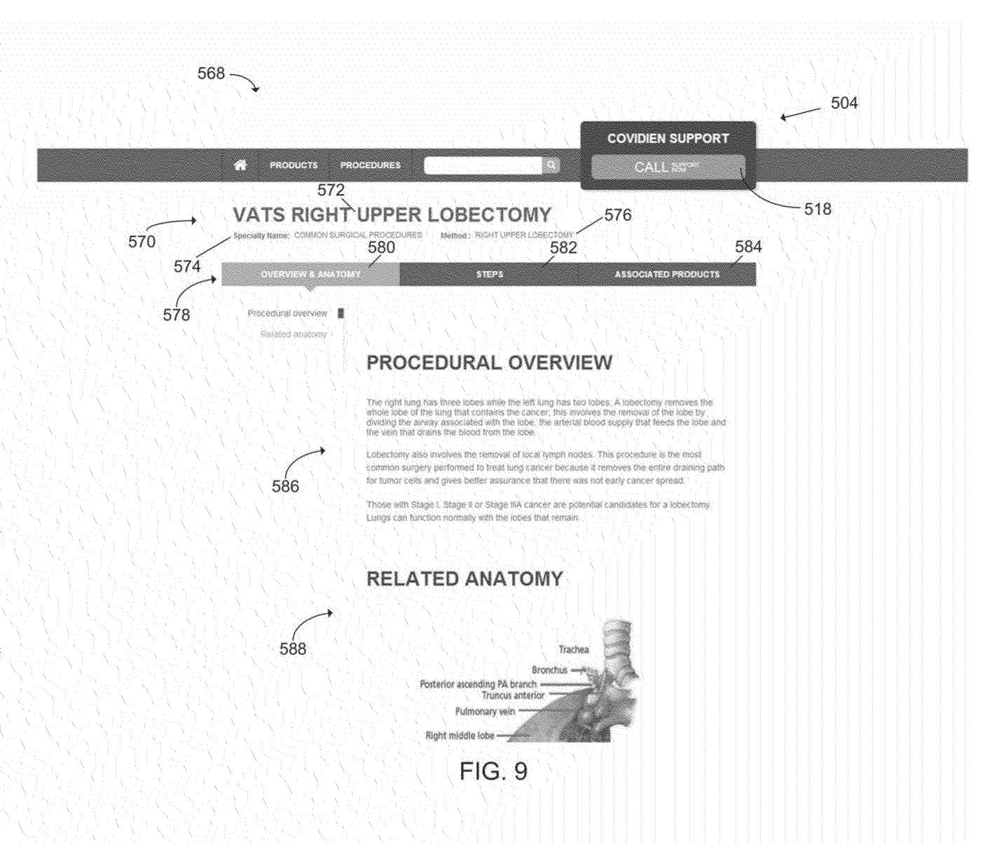

Once a medical procedure 564 has been activated in step S408, web platform 210 presents the user with a view 568 (FIG. 9) in step S410 providing the user with additional information related to the activated medical procedure 564. View 568 presents the user with procedure identifying information 570 including, for example, procedure name 572, specialty name 574, and method name 576. View 568 also includes a menu bar 578 that is activatable by the user to provide the user with functional information related to the activated medical procedure 564, in this example, the VATS Right Upper Lobectomy procedure 566. Menu bar 578 includes an “overview & anatomy” tab 580, a “steps” tab 582, and an “associated products” tab 584. Each tab 580, 582, and 584 is independently activatable by the user to present procedure specific information for the activated medical procedure 564.

As shown in FIG. 9, for example, “overview & anatomy” tab 580 provides the user with general information relating to the activated medical procedure 564 including, for example, a brief description of the procedure 586 and related anatomy 588 for the medical procedure, and may include an image or picture of the related anatomy with labels identifying various portions of the related anatomy.

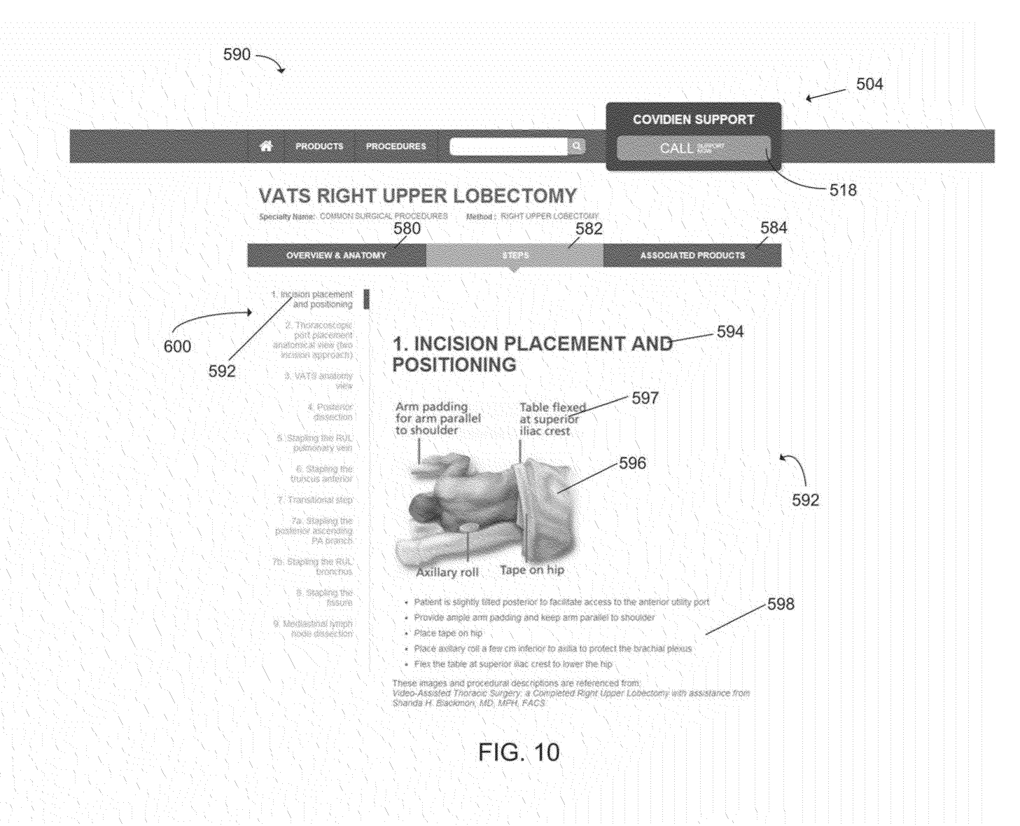

As shown in FIG. 10, for example, when the user activates the “steps” tab 582, web platform 210 presents the user with a view 590 that provides the user with specific information relating to the steps of the activated medical procedure 564. For example, view 590 provides the user with specific procedure step sections 592. Each step section 592 provides detailed information for the user's consideration about a particular step 594 within the activated medical procedure 564 including an illustration or picture of the relevant anatomy 596 for the particular step 594 and sub-steps 598 for performing the particular step section 594. The illustration of the relevant anatomy 596 may include identifiers 597 for identifying relevant portions of the anatomy. The user may scroll through the step sections 592 using input device 112. A list 600 of the step sections 592 may also be provided in view 590 to allow the user to quickly access a desired step section 592. If the medical products being used in the OR are interfaced with client device 100 and web platform 210, web platform 210 may automatically update the procedure step based on actions occurring within the OR. For example, client device 100 or web server 210 may process a video feed from a laparoscope interfaced or associated with client device 100 and may dynamically update the particular step 594 or sub-steps 598 presented to the user based on the processed video feed without other user interaction.

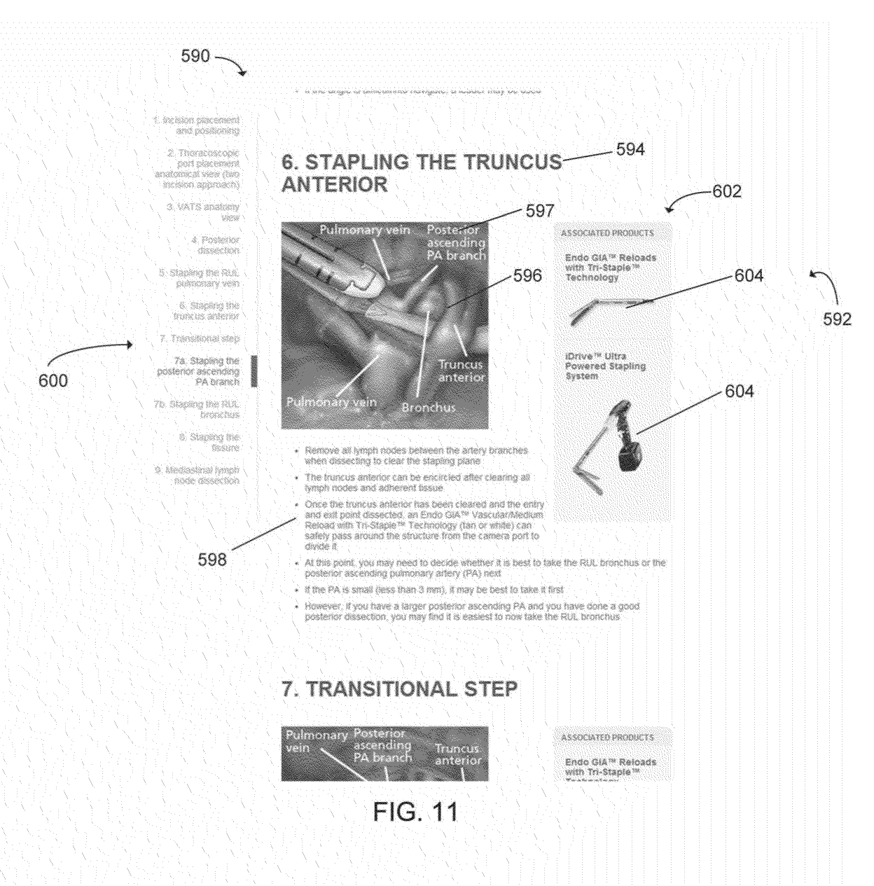

Each step section 592 may also include a list of associated products 602 that indicates to the user which medical products 604 are required or may be used for the particular step section 592, as shown, for example, in FIG. 11. Each medical product 604 may be activated in step S412 to present the user with view 526 in step S406 as described above for product specific self-help support. By providing associated medical products 602, the user, for example, a nurse, surgeon, or other medical staff, is provided with a roadmap for the particular surgical procedure being performed in the OR. This allows the medical staff to proactively prepare and present the associated medical products 602 to the surgeon at the appropriate step of the medical procedure.

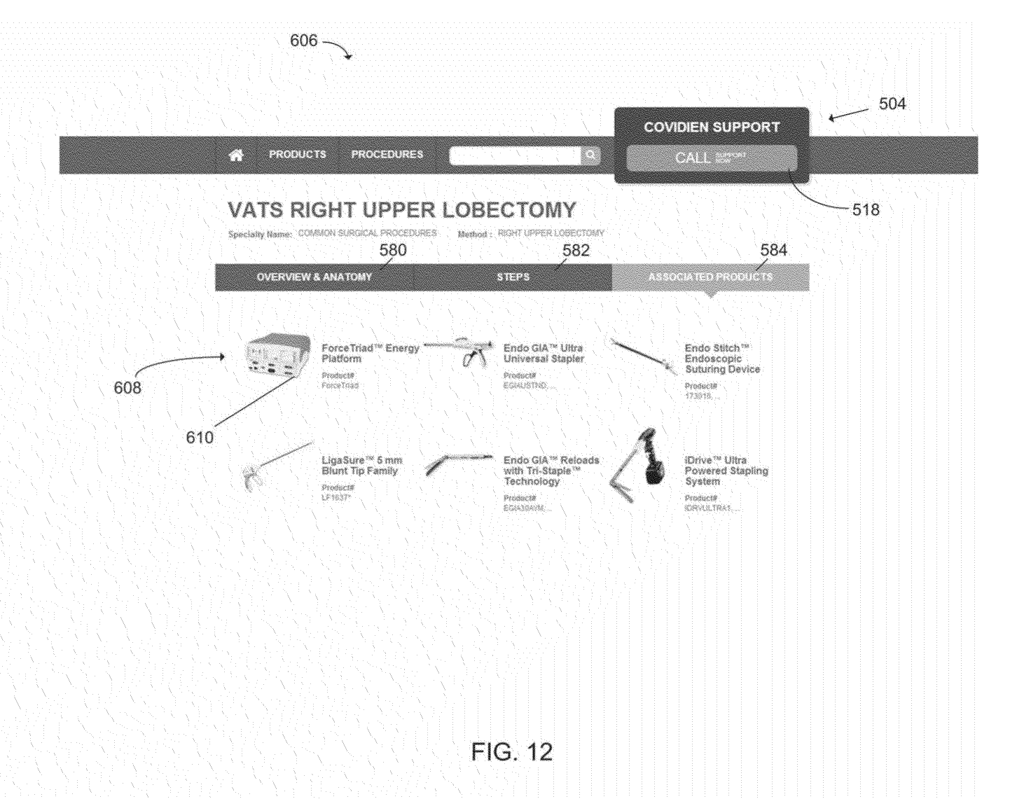

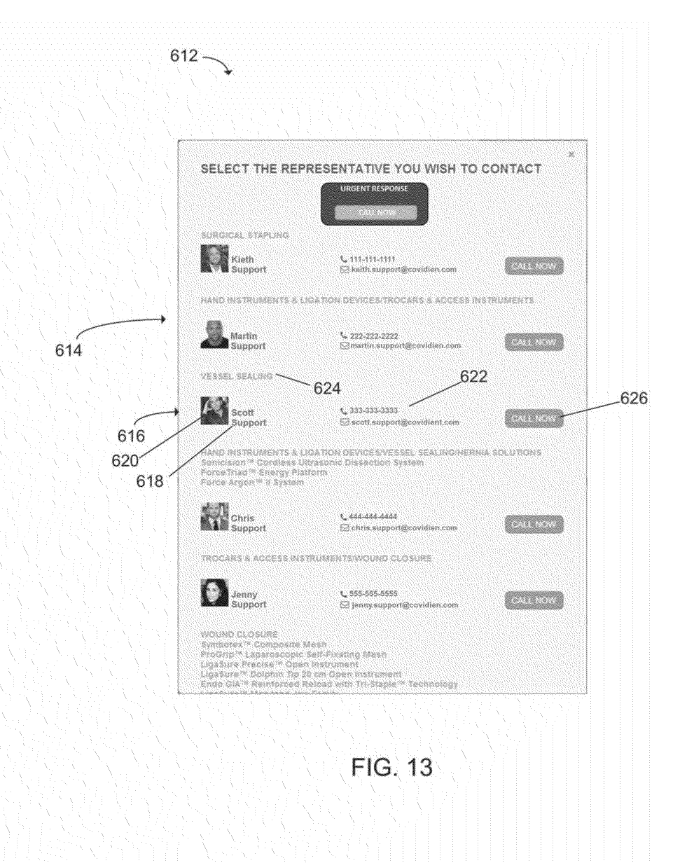

When the user activates the “associated products” tab 584, web platform 210 presents the user with a view 606 that provides the user with a list 608 of medical products 610 associated with the activated medical procedure 564 as shown, for example, in FIG. 12. List 608 may be display as thumbnails, details, or any other form of display for providing a user with information related to the associated medical products 610. Each medical product 610 may be activated in step S412 to present the user with view 526 in step S406 as described above for product specific self-help support.

If the user activates the “call support now” button 518 of any of views 500, 520, 526, 552, 560, 568, 590, or 606, web platform 210 determines whether the current view is a general view or a product specific view in step S414. General views provide the user with a list of one or more products, families of products, procedures, families of procedures, or other similar self-help information. Example of general views may include, for example, views 500, 520, 560, 568, 590, and 606. Product specific views provide the user with details about the use of a specific product or family of products. Examples of product specific views may include, for example, views 526 and 552. For example, as shown in FIG. 6, the real-time product support option 504 found in the product specific views further provides a primary product support staff member 505 that is associated with the particular medical product 522 or family of medical products 506 (FIG. 5). For example, when a specific medical product family 506 is selected from menu 524, the primary real-time product support staff member 505 that is associated with the selected family 506 may be displayed on real-time product support option 504.

If the user activates the “call support now” button 518 in a general view, for example, in view 500 of FIG. 4, the user is presented with a view 612 in step S416 as shown, for example, in FIG. 13. View 612 provides the user with a list of product support staff 614 including one or more primary product support staff members 616 that the user may contact to receive real-time product support. Each of the primary product support staff members 616 includes a name 618, picture 620, contact information 622, one or more associated product families 624, and a “call support now” button 626 that is activatable by the user to contact the particular primary product support staff member 616.

If the user activates the “call support now” button 518 in a product specific view, for example, in view 526 of FIG. 6, or if the user activates the “call support now” button 626 for a particular primary product support staff member 616 in view 612, web platform 210 attempts to initiate a real-time product support connection between client device 100 and the product support device 300 associated with the primary product support staff member 505 associated with the product specific view or the primary product support staff member 616 that is activated in step S418. For example, the real-time product support connection may be initiated via web server 200 where each of client device 100 and product support device 300 connect to a meeting room hosted by web server 200 or the real-time product support connection may be initiated directly between client device 100 and product support device 300.

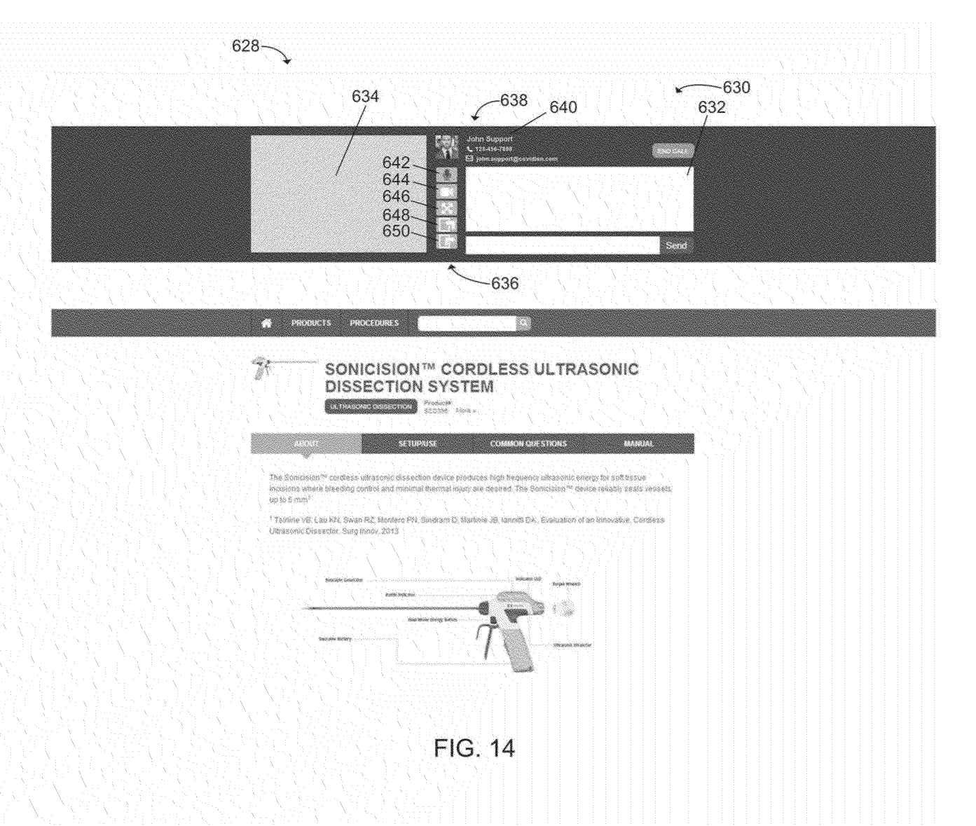

For example, as shown in FIG. 3, during initialization of the connection between client device 100 and product support device 300, web platform 210 or client device 100 may ring or otherwise indicate to product support device 300 of the primary product support staff member 505, 616 that a connection is desired in step S420. If web platform 210 determines that the primary product support staff member 505, 616 is available in step S420, for example, if the primary product support staff member 505, 616 answers, a connection is established between the client device 100 and the product support device 300 of the primary product support staff member 505, 616 in step S422 and web interface 210 presents the user with a view 628, as shown in FIG. 14, which will be described in more detail below.

Alternatively, if, after a pre-determined number of rings, for example, two rings, web platform 210 determines in step S420 that the primary product support staff member 505, 616 is not available, web server 210 may initiate an additional connection with the product support device 300 of a secondary product support staff member associated with the specified medical product or family of medical products. The additional connection may replace the original connection or may alternatively run concurrently with the original connection where, for example, the product support device 300 associated with the primary product support staff member 505, 616 may continue to ring. Web platform 210 may present to the user a message indicating that a secondary product support staff member is also being contacted. The secondary product support staff member may, for example, be a primary product support staff member associated with another medical product or family of medical products that has some knowledge of the particular medical product or family of medical products that is of interest to the user or may be another product support staff member having knowledge of the particular medical product or family of medical products.

If the web platform 210 determines that the secondary product support staff member is available in step S424, for example, if the secondary product support staff member answers, a connection is established in step S426 with the product support device 300 of the secondary product support staff member and web platform 210 presents the user with view 628, as shown in FIG. 14, which will be described in more detail below. After the connection has been established with the secondary product support staff member, web platform 210 may provide the primary product support staff member 505, 616 with the option to join the connection in step S428, for example, as the primary product support staff member 505, 616 becomes available.

Alternatively, if, after a pre-determined number of additional rings, for example, two more rings (for a total of four rings), the web server determines in step S424 that a connection with the product support device 300 of the secondary product support staff member is not successful, web platform 210 may initiate an additional connection with a product support device 300 associated with a general call center. The additional connection may replace the connections to the product support devices 300 of either or both of the primary and secondary product support staff members or may alternatively run concurrently with the connections where, for example, the product support devices 300 associated with the primary or secondary product support staff members may continue to ring. Web platform 210 may present to the user a message indicating that a general call center is also being contacted.

If the web platform 210 determines that the general call center is available in step S430, for example, if the product support staff member of the general call center answers, a connection is established in step S432 with the product support device 300 of the product support staff member of the general call center and web platform 210 presents the user with view 628, as shown in FIG. 14, which will be described in more detail below. After the connection has been established with the general call center product support staff member, web platform 210 may provide the primary product support staff member 505, 616 and/or the secondary product support staff member with the option to join the connection in steps S428 and S434, for example, as the primary product support staff member 505, 616, and/or the secondary product support staff member becomes available.

If, after a pre-determined number of rings, for example, three additional rings (for a total of seven rings), the web platform 210 determines in step S430 that a connection with the product support device 300 associated with the general call center is not successful, web platform 210 may present the user with a message indicating that product support is unavailable and may provide the user with the option to leave a message in step S436. Although described above with reference to example numbers of rings, it is contemplated that each pre-determined number of rings may be adjusted or changed as needed by web platform 210. For example, during periods of high activity, the number of rings during any of steps S420, S424, or S430 may be adjusted as needed.

When a connection is established with a product support device 300 of any of the primary product support staff member 505, 616, the secondary product support staff member(s), or the product support staff member(s) of the general call center in steps S422, S426, or S432, web platform 210 presents the user with view 628, as shown in FIG. 14, which provides the user with a real-time interface 630 including a text-based communication interface 632, a video interface 634, a control interface 636, and an identification section 638 for identifying a connected product support staff member 640. Each of the product support staff members has the ability to connect additional product support staff members as needed providing a conference call scenario of knowledgeable individuals to assist the user.

As used herein, the steps of 418, 420, 422, 424, 426, 428, 430, 432, 433, 434, 436, as shown in FIGS. 3A and 3B, are referred to as the “Call Support Tree.” The Call Support Tree described above is provided as one example of a customization and shall not be considered limiting. For example, where multiple product support members 640 are available, the Call Support Tree can be customized to call a single product support staff member first, two product support staff members second and all remaining product support staff members third.

In another embodiment, in the event the user is unsure which product support option of view 612 to select from or in the event of some emergency, the user may select the Urgent Response Option of step S440, as shown in FIG. 3B, and option 613, as shown at FIG. 13. Upon the selection of the Urgent Response Option 613 each of the primary product support staff member S422, the secondary product support staff member(s) S426, and the product support staff member(s) of the general call center S432 will be called simultaneously. Upon connection with each product support staff member, the most knowledgeable product support staff member will remain on the call to provide support or redirect the call as necessary, as shown at S433 of FIG. 3B. Once the most knowledgeable person is on the call, the method returns to step S436.

The user may communicate with the product support staff member 640 via text-based communication interface 632, orally via input device 112 and output device 113 of client device 100, for example, a microphone, speakers, and/or a headset, or visually using camera 108 and video interface 634. When the connection is established, product support staff member 640 is also presented with view 628. For brevity, the features of view 628 will only be described below with reference to the user although each of the features described below may also be activated by the product support staff member 640.

Control interface 638 provides the user with control buttons for controlling or activating various product support features. For example, voice and video communication may initially be turned off when the connection is established and may be turned on by the user and/or product support staff member 640 by activating a microphone button 642 or camera button 644, respectively. The user may also toggle between real-time interface 630 and a full screen mode (not shown) by activating the full screen button 646. During product support, the user may push the current view of web platform 210 that the user is currently viewing to the product support device 300 of the product support staff member 640 or may pull the current view of web platform 210 that the product support staff member 640 is viewing to the client device 100 for presentation by web platform 210 to the user by activating the push button 648 and pull button 650, respectively. The product support staff member 640 may likewise active the push button 648 or pull button 650 to push or pull views of web platform 210 to or from the client device 100. This co-navigation feature allows the user and the product support staff member 640 to quickly match the subject matter being viewed to allow for more targeted product support. In addition, both the product support staff members 640 and user may transfer media files between each other.

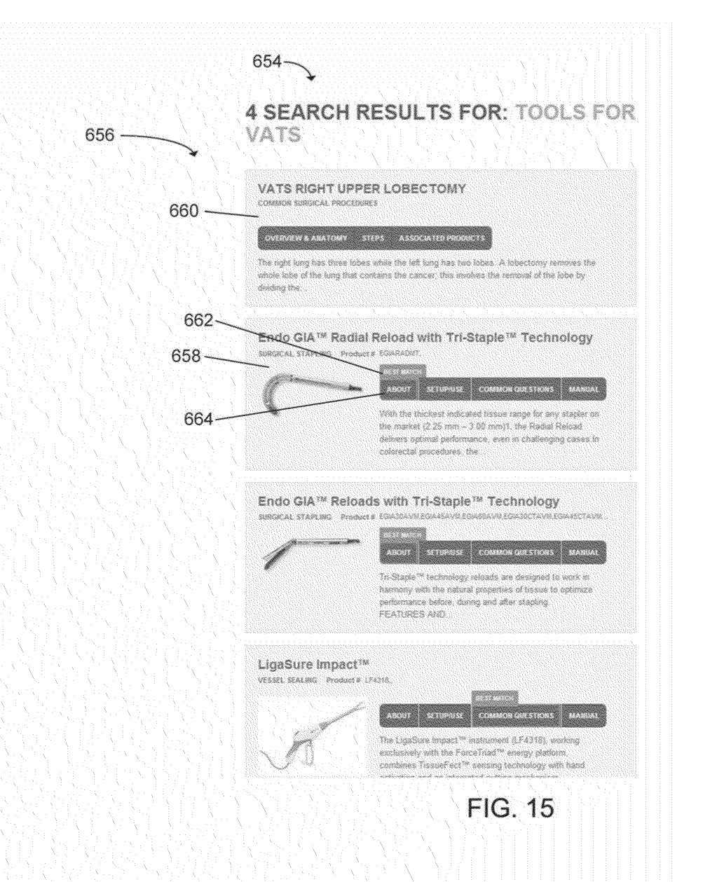

Once the user has finished self-help product support for either a specific product or procedure, or real-time product support, the user determines if additional product support is required in step S436. If additional product support is required, the user returns to step S402 to select the type of support that is desired. For example, if the user is unsure where within web platform 210 the desired product support can be found, the user may enter a search query in search box 652, shown for example in FIG. 4, and is presented with a view 654 as shown, for example, in FIG. 15, providing the user with related search results 656. If no further product support is required, the user may instead exit web portal 210.

The search query in search box 652 may be written or spoken by the user. In the event the user decides to dictate a search query, a microphone button 653 may be pressed and the user speaks the search query and voice recognition is used to convert the spoken search into text. In addition to voice recognition used to convert the spoken search query into text, a hands-free mode can be initiated through the use of voice activated commands after which questions may also be asked. A series of prompts may be provided to which the user responds in order to confirm requests, and identify the appropriate response to the request, such hands-free systems are common in many mobile phone systems as well as BLUETOOTH® hands-free systems.

Following a search, each related search result 656, for example, a medical product 658 or a medical procedure 660 may include an indicator 662, for example, an indicator of a best match, next to a corresponding category portion 664 of the particular result 656. In the example shown in FIG. 15, for example, the indicator 662 may be attached to the “about” tab 664 of the product specific information for the medical product 658.

During product support, as described above, web platform 210 may provide the product support staff member or another technician access to a medical product via an interface with client device 100 to allow the product support staff member or technician to control the platform, run diagnostics, and/or make repairs. As an alternative, where a medical product is either networked (e.g., via a hospital intranet or via wi-fi to the internet) or connected to a networked device, data regarding the current usage, detected imminent failures, or other operational data may be provided to the web server 200. One such system which collects such data is the Covidien GATEWAY™ system which collects among other things operational and usage data of medical products. Utilizing this data collected from the networked medical product, the web platform may function predictively and push product support data in anticipation of the needs of the user. For example, if an imminent stapler jam is detected, the web platform 210 may present a page detailing resolving the jam to the user. In addition, the web platform 210 may alert the user to the imminent jam.

In yet a further embodiment of the present disclosure, by receiving real-time usage information regarding a medical product the web platform 210 can make recommendations regarding proper usage. Again using a stapler as an example, when the stapler senses tissue that is different than expected, the web platform 210 can receive this information and push recommendations for changing the stapler load to address this difference.

Still further, as pages of web platform 210 are accessed from various locations, this data may be pushed to sales staff as well as support staff. For example if a user accesses a particular page regarding troubleshooting a stapler, this information is relevant to both the sales staff and the support staff. To the support staff this information is useful as it indicates a potential call for which they can prepare. To the sales staff, repeated accessing of a particular page by a user or group of users may identify a problem in their understanding, a bad batch of medical products, or some other issue that is best addressed by the sales staff before a user makes a decision to no longer use that product. Still further, such information being presented to both these groups of individuals can be useful in confirming whether the issue being complained of by the user is a result of improper usage, improper training, or some other concern such as a manufacturing defect. The alerting of the sales and support staff can be by a variety of means including direct texting the individual, email, pop-up notification from a supported application, or as part of a regularly kept record forming part of the sales staff customer relationship management (CRM) software.

Although embodiments have been described in detail with reference to the accompanying drawings for the purpose of illustration and description, it is to be understood that the inventive processes and apparatus are not to be construed as limited thereby. It will be apparent to those of ordinary skill in the art that various modifications to the foregoing embodiments may be made without departing from the scope of the disclosure.

What is claimed is:

1. A system for providing medical product support to a client device in an operating room comprising:
a processor and memory associated with the processor, the memory including instructions that, when executed by the processor, configures the processor to:
receive a product support request from the client device; and
transmit a web platform including at least one view to the client device in response to the product support request, the at least one view being configured to present the client device with self-help product support information for at least one medical procedure, and the at least one view further presenting at least one medical product associated with the at least one medical procedure.

2. The system according to claim 1, wherein the self-help product support information for the at least one medical procedure presents at least one step of the at least one medical procedure.

3. The system according to claim 2, wherein the at least one medical product associated with the at least one medical procedure is associated with the at least one step of the at least one medical procedure.

4. The system according to claim 1, wherein the web platform further includes at least one product specific view configured to present the client device with self-help product support information for the at least one medical product associated with the at least one medical procedure, the at least one medical product being activatable in the self-help product support information for the at least one medical procedure by a user of the client device to access the at least one product specific view.

5. The system according to claim 4, wherein the at least one product specific view includes a real-time product support call option that is activatable by the user of the client device to access real-time product support for the activated medical product.

6. The system according to claim 5, wherein the real-time product support call option includes at least one of a text-based interface, an audio-based interface, a video-based interface, or an audio-visual based interface.

7. The system according to claim 1, wherein the at least one view presenting self-help product support information for the at least one medical procedure includes a real-time product support call option that is activatable by the user of the client device to access real-time product support for the at least one medical procedure.

8. The system according to claim 7, wherein the real-time product support call option includes at least one of a text-based interface, an audio-based interface, a video-based interface, or an audio-visual based interface.

9. A non-transitory computer-readable storage medium encoded with instructions that, when executed by a processor, configures the processor to:
receive a product support request from the client device; and
transmit a web platform including at least one view to the client device in response to the product support request, the at least one view being configured to present the client device with self-help product support information for at least one medical procedure, the at least one view further presenting at least one medical product associated with the at least one medical procedure.

10. The non-transitory computer-readable storage medium according to claim 9, wherein the self-help product support information for the at least one medical procedure presents at least one step of the at least one medical procedure.

11. The non-transitory computer-readable storage medium according to claim 10, wherein the at least one medical product associated with the at least one medical procedure is associated with the at least one step of the at least one medical procedure.

12. The non-transitory computer-readable storage medium according to claim 9, wherein the web platform further includes at least one product specific view configured to present the client device with self-help product support information for the at least one medical product associated with the at least one medical procedure, the at least one medical product being activatable in the self-help product support information for the at least one medical procedure by a user of the client device to access the at least one product specific view.

13. The non-transitory computer-readable storage medium according to claim 12, wherein the at least one product specific view includes a real-time product support call option that is activatable by the user of the client device to access real-time product support for the activated medical product.

14. The non-transitory computer-readable storage medium according to claim 13, wherein the real-time product support call option includes at least one of a text-based interface, an audio-based interface, a video-based interface, or an audio-visual based interface.

15. The non-transitory computer-readable storage medium according to claim 9, wherein the at least one view presenting self-help product support information for the at least one medical procedure includes a real-time product support call option that is activatable by the user of the client device to access real-time product support for the at least one medical procedure.
